(19) United States
(12) Patent Application Publication
(10) Pub. No.: US 2025/0018812 A1
(43) Pub. Date: Jan. 16, 2025

(54) AUTOMATIC CHARGING SYSTEM

(71) Applicant: TOYOTA JIDOSHA KABUSHIKI KAISHA, Toyota-shi Aichi-ken (JP)

(72) Inventors: Masaaki SATO, Susono-shi Shizuoka (JP); Takeru SHIRASAWA, Sunto-gun Shizuoka (JP); Yusuke SAITO, Gotenba-shi Shizuoka (JP); Teruaki HAIBARA, Ashigarakami-gun Kanagawa (JP)

(73) Assignee: TOYOTA JIDOSHA KABUSHIKI KAISHA, Toyota-shi Aichi-ken (JP)

(21) Appl. No.: 18/762,067

(22) Filed: Jul. 2, 2024

(30) Foreign Application Priority Data
Jul. 10, 2023 (JP) 2023-113056

(51) Int. Cl. B60L 53/37; B60G 17/052; B60L 53/16; B60L 53/30; B60L 53/66

(52) U.S. Cl. CPC B60L 53/37; B60G 17/0525; B60L 53/16; B60L 53/305; B60L 53/66; B60L 2240/28

(57) ABSTRACT

An automatic charging system includes: a vehicle driven by power; a charger having a charging cable having a charging connector; a position information acquisition device for obtaining position information of a charging port of the vehicle; a charging robot having a robot arm; and a detection device, which detects an operation of the charging port displaced in a vertical direction. Further, the charging robot insert the charging connector into the charging port based on the position information, and in a case where the detection device detects the operation of the charging port displaced in the vertical direction during a time period from when the position information acquisition device acquires the position information to when the insertion of the charging connector into the charging port is completed, the acquisition of the position information by the position information acquisition device is newly done again.

### CROSS-REFERENCE TO RELATED APPLICATIONS

The present application claims priority to and incorporates by reference the entire contents of Japanese Patent Application No. 2023-113056 filed in Japan on Jul. 10, 2023.

### BACKGROUND

The present disclosure relates to an automatic charging system.

Japanese Laid-open Patent Publication No. 2021-032721 discloses a technique in which the power supply robot holds the power supply connector of the power supply facility, moves itself to the vehicle parked in the parking space, connect the power supply connection to the inlet provided in the vehicle, and charges the power from the power supply facility to the battery of the vehicle.

### SUMMARY

There is a need for providing an automatic charging system in which the charging connector can be inserted into the charging port based on the latest position information of the charging port.

According to an embodiment, an automatic charging system includes: a vehicle, which is driven by power supplied from a power storage device; a charger, which is equipped with a charging cable having a charging connector; a position information acquisition device for obtaining position information of a charging port of the vehicle located in a parking space; a charging robot having a robot arm, which grasps the charging connector and automatically insert and remove the charging connector into and from the charging port; and a detection device, which detects an operation of the charging port displaced in a vertical direction. Further, the charging robot is configured to insert the charging connector into the charging port based on the position information to supply power from the charger to the power storage device for charging, and in a case where the detection device detects the operation of the charging port displaced in the vertical direction during a time period from when the position information acquisition device acquires the position information to when the insertion of the charging connector into the charging port is completed, the acquisition of the position information by the position information acquisition device is newly done again.

### BRIEF DESCRIPTION OF THE DRAWINGS

FIG. 1 is a diagram illustrating a parking lot applying the automatic charging system according to an embodiment;

FIG. 2 is a diagram illustrating a schematic configuration of an automatic charging system to the embodiment;

FIG. 3A is a diagram illustrating a position of the charging port when acquiring the position information to the charging port;

FIG. 3B is a diagram illustrating a state in which the position of the charging port is shifted in the vertical direction after obtaining the position information of the charging port; and

FIG. 4 is a flowchart illustrating an example of an automatic charging control according to the embodiment.

### DETAILED DESCRIPTION

In the related art, if the first recognized position of the charging port is shifted during charging by the power supply robot, the power supply connector may not be able to be inserted into the charging port.

Hereinafter, an embodiment of an automatic charging system according to the present disclosure. Note that the present disclosure is not limited by the present embodiment.

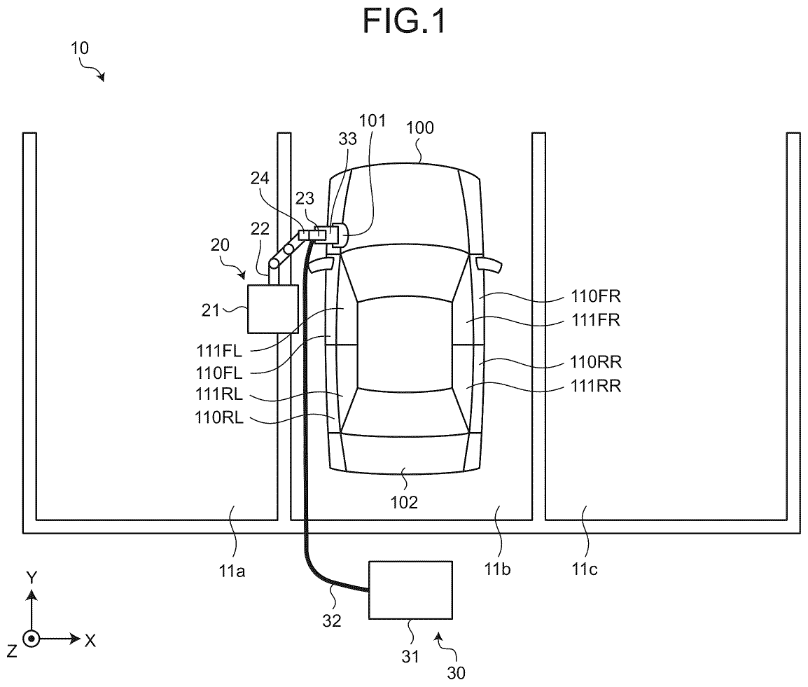

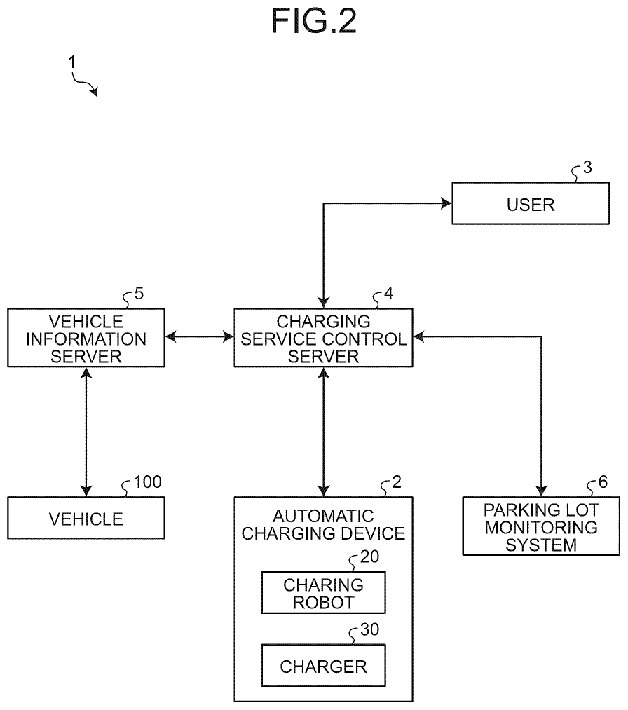

FIG. 1 is a diagram illustrating a parking lot 10 to which the automatic charging system 1 according to an embodiment. Incidentally, FIG. 1 is a view of the parking lot 10 from above. FIG. 2 is a diagram illustrating a schematic configuration of an automatic charging system 1 according to the embodiment.

FIG. 1 illustrates three parking spaces 11a, 11b, 11c of a plurality of parking spaces provided in the parking lot 10 which is a parking facility, the parking spaces 11a, 11b, 11c are used as the charging space. The three parking spaces 11a, 11b, 11c are arranged side by side in the lateral direction of the parking spaces 11a, 11b, 11c (vehicle lateral direction). In the following explanation, when not particularly distinguished a parking space 11a, 11b, or 11c, the parking space may be simply referred to as parking space 11.

In FIG. 1, the vehicle 100 to be charged is parked in the parking space 11b. The vehicle 100 includes a charging port 101, a trunk 102, front and rear left and right doors 110FL, 110FR, 110RL, and 110RR, front and rear left and right windows 111FL, 111FR, 111RL, and 111RR, a door open and close detection sensor, a trunk open and close detection sensor, and an electric air suspension or the like.

The charging port 101 is provided on the vehicle front side of the front left side of the door 110FL in the vehicle 100. The front and rear left and right doors 110FL, 110FR, 110RL, 110RR are provided to be opened and closed through a hinge with respect to the vehicle body. The door opening and closing detection sensor is provided corresponding to each of the front and rear left and right 10 doors 110FL, 110FR, 110RL, and 110RR. The vehicle controller can detect the opening and closing operations of the front, rear, left, and right doors 110FL, 110FR, 110RL, 110RR based on the detection result of the door opening and closing detection sensor. In the following explanation, when the door is not particularly distinguished from among the front and rear left and right doors 110FL, 110FR, 110RL, and 110RR, the door may be simply referred to as a door 110.

The trunk 102 is a luggage compartment provided in the vehicle rear, and is provided to be opened and closed through a hinge relative to the vehicle body. The trunk opening and closing sensor is provided corresponding to the trunk 102. The vehicle controller, based on the detection result of the trunk opening and closing detection sensor, can detect the opening and closing operation of the trunk 102.

The Front and rear left and right windows 111FL, 111FR, 111RL, and 111RR are provided to be opened and closed in front and rear left and right doors 110FL, 110FR, 110RL, and 110RR, respectively.

The electric air suspension, for example, when an ascending switch or a descending switch provided in the vicinity of the driver's seat is depressed by an occupant, by supplying compressed air to an air spring interposed between the vehicle body and the axle or discharging compressed air from the air spring, performs vehicle height adjustment in accordance with the number of depressions. The vehicle controller is capable of detecting that when the up switch or the down switch is depressed, the electric air suspension is operated to adjust the vehicle height by receiving a depression signal including the number of depressions.

In the vicinity of the parking spaces 11a, 11b, and 11c, a charging robot 20 and the charger 30 are provided to be used for charging the vehicle 100 parked in the parking spaces 11a, 11b, and 11c. In the automatic charging system 1 according to the embodiment, the automatic charging device 2 is constituted by the charging robot 20 and the charger 30. The charging robot 20 and the charger 30 are configured to communicate with each other.

In the automatic charging system 1 according to the embodiment, the automatic charging by the automatic charging device 2 for the vehicle 100 parked in the parking space 11 of the parking lot 10 is managed and performed by the charging service control server 4. The charging service control server 4 is provided with a server control device for implementing various controls related to automatic charging at least as illustrated in FIG. 2.

The charging service control server 4 is communicatively configured with the communication terminal owned by the user 3 of the vehicle 100 parked in the parking space 11 of the parking lot 10. The charging service control server 4 is capable of receiving various information such as charging reservation for the vehicle 100 transmitted from the communication terminal of the user 3.

Further, the charging service control server 4 is communicably configured with the parking lot monitoring system 6 for monitoring the parking lot 10. The charging service control server 4, based on the detection result of the vehicle detecting device constituted by the imaging device and various sensors having the parking lot monitoring system 6, can detect the presence or absence of the vehicle 100 to the parking space 11a, 11b, and 11c (parking state).

Further, the charging service control server 4 is configured to communicate with the vehicle 100 through the vehicle information server 5 capable of communicating with the vehicle 100 parked in the parking space 11. The charging service control server 4 can receive information from the vehicle 100 of an State Of Charge (SOC) of the battery, which is a power storage device mounted on the vehicle 100 and information about such required power, and various information such as vehicle information about the position of the charging port 101 of the vehicle 100, via the vehicle information server 5. Further, the charging service control server 4 can transmit such as an instruction signal for freely opening and closing the unlocking and charging lid of the charging port 101 of the vehicle 100 to the vehicle 100 via the vehicle information server 5.

Further, the charging service control server 4 is communicably configured with the automatic charging device 2 provided in the parking lot 10 (charging robot 20 and charger 30). The charging service control server 4 can transmit various information such as vehicle information about the position of the charging port 101 of the information and the vehicle 100 about the amount of charging power of the battery mounted on the vehicle 100, to the automatic charging device 2 (charging robot 20 and charger 30). Further, the charging service control server 4 can transmit signals instructing the charging start on the basis of the charging reservation from the user 3 to the automatic charging device 2 (charging robot 20 and the charger 30).

The charging robot 20 includes the robot body 21, the robot arm 22, the robot hand 23, a camera 24, and a robot controller. The robot body 21 is an autonomously movable (autonomously travelable) mobile. The robot arm 22 has a base end portion connected to the robot body 21. The robot hand 23 is provided at the distal end portion of the robot arm 22. The camera 24 is an imaging device provided at the tip portion of the vicinity of the robot hand 23 in the robot arm 22. As the camera 24, for example, a stereo camera can be used. The robot controller is provided in the robot main body 21 and can execute various controls and various calculations, etc. related to the charging work by the charging robot 20. For example, the vehicle lateral direction of the parking lot 10 (lateral direction) is referred to as an X-axis, the vehicle longitudinal direction in the parking lot 10 (longitudinal direction) is referred to as a Y-axis, the vehicle height direction from the ground in the parking lot 10 is referred to as a Z-axis. Then, the robotic controller can calculate the position coordinates (e.g., YZ coordinates) of the charging port 101 in the image data of the charging port 101 in the vehicle 100 captured by the camera 24.

The charger 30 includes a charger body 31, a charging cable 32, and a charging connector 33. Further, the charger body 31 is fixed to the ground.

In the charging system of the parking lot 10 according to the embodiment, the charger 30 is arranged to correspond to the three parking spaces 11a, 11b, and 11c. In a state of FIG. 1, it is capable of charging using a charger 30 to the vehicle 100 parked in the parking space 11b.

For example, when automatically charging is performed on the vehicle 100 parked in the parking space 11b by using the charger 30, the robot body 21 of the charging robot 20 autonomously moves to a position to grasp the charging connector 33 of the charger 30 by the robot hand 23 by extending the robot arm 22 of the charging robot 20. The charging robot 20 recognizes the charging connector 33 by a camera 24 provided on the robot arm 22 and grasps the charging connector 33 by the robot hand 23. Thereafter, the robot body 21 of the charging robot 20 autonomously moves to a position where the charging connector 33 can be inserted into the charging port 101 of the vehicle 100. Then, the charging robot 20 acquires the position information of the charging port 101 recognizes the charging port 101 of the vehicle 100 by the camera 24 provided on the robot arm 22, based on the position information of the charging port 101 acquired (position coordinates), and insert the charging connector 33 to the charging port 101 of the vehicle 100 by extending the robot arm 22. When the charging connector 33 is inserted to the charging port 101 of the vehicle 100, the charger 30 supplies power to the vehicle 100 via the charging cable 32 and the charging connector 33 from the power supply device provided in the charger body 31, and charges the battery, which is provided in the vehicle 100 as a power storage device. Further, after inserting the charging connector 33 into the charging port 101 of the vehicle 100, the charging robot 20 releases the robot hand 23 from the charging connector 33 to move the robot arm 22 back to the preset arm reference position.

Upon completion of charging of the vehicle 100, the robot body 21 of the charging robot 20 autonomously moves to a position where the robot arm 22 is extended to grasp the charging connector 33 inserted into the vehicle 100 by the robot hand 23. The charging robot 20 then grasps the charging connector 33 by the robot hand 23 and withdraws the charging connector 33 from the vehicle 100. Thereafter, in order to return the charging connector 33 to the plug reference position preset in the charger 30, the robot body 21 of the charging robot 20 is moved to the charger 30 side. Then, the charging robot 20 extends the robot arm 22 to return the charging connector 33 to the plug reference position.

By doing this, it is possible to perform automatic charging on each vehicle 100 parked in the parking spaces 11a, 11b, and 11c of the parking lot 10 by the automatic charging device 2 (charging robot 20 and charger 30).

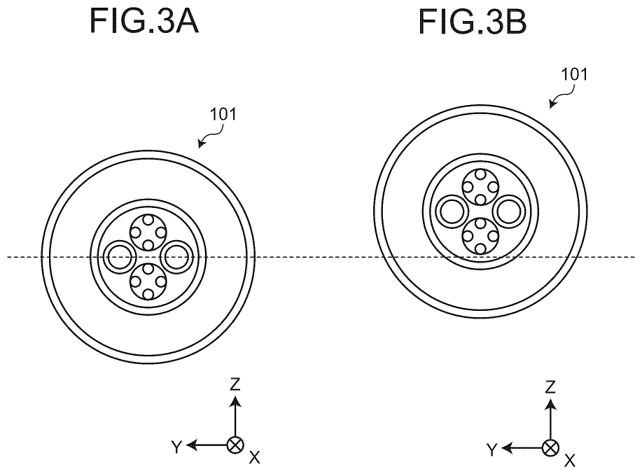

FIG. 3A is a diagram illustrating the position of the charging port 101 when acquiring the position information to the charging port 101. FIG. 3B is a diagram illustrating a state in which the position of the charging port 101 after obtaining the position information of the charging port 101 is shifted in the vertical direction.

As illustrated in FIG. 3A, after setting the target coordinates of the charging port 101 of the vehicle 100, as illustrated in FIG. 3B, the position of the charging port 101 may be found changed in the vertical direction. That is the part FIG. 3B illustrates the case where the position of the charging port 101 is shifted upward in the vertical direction.

The position of the charging port 101 may be shifted in the vertical direction when, for example, the door 110 is opened to allow an occupant to get on or off, the trunk 102 is opened to load or unload a load, or the vehicle height of the vehicle 100 is adjusted by the electric air suspension. Thus, in such a state where the position of the charging port 101 is shifted in the vertical direction, it may not be possible to correctly connect even trying to connect the charging connector 33 to the charging port 101. Further, during the connection of the charging connector 33 is fitted to the charging port 101, if the position of the charging port 101 is shifted in the vertical direction, there is a possibility that lead to damage to the vehicle components.

For example, during the time from the acquisition of the position information of the charging port 101 of the vehicle 100 by the camera 24 of the charging robot 20 until the insertion of the charging connector 33 to the charging port 101 is completed, if the door 110 is opened, getting on and off of the occupant occurs, the vehicle weight of the vehicle 100 is changed by changing the vehicle height, there is a possibility that the position of the charging port 101 is shifted. Further, between the time period from when the position information of the charging port 101 of the vehicle 100 by the camera 24 of the charging robot 20 is acquired to when the insertion of the charging connector 33 to the charging port 101 is completed, if the trunk 102 is opened, loading and unloading of the load in the trunk 102 occurs, the vehicle weight of the vehicle 100 is changed by changing the vehicle height, as a result, there is a possibility that the position of the charging port 101 is shifted. Similarly, during the time from when the position information of the charging port 101 of the vehicle 100 by the camera 24 of the charging robot 20 is acquired to when the insertion of the charging connector 33 to the charging port 101 is completed, if the vehicle height adjustment is done to raise the vehicle height of the vehicle 100 by the electric air suspension, there is a possibility that the position of the charging port 101 is shifted by the vehicle height is changed.

Therefore, in the automatic charging system according to the embodiment, between the time period from when the position information of the charging port 101 by the position information is acquired to when the insertion of the charging connector 33 to the charging port 101 is completed, if the position shift in the vertical direction of the of the charging port 101 is detected with using a detection device, the charging operation by the charging robot 20 is paused, and control to repeat the acquisition of the position information of the charging port 101 is performed. As the position information acquisition device, for example, it is possible to use a camera 24 provided on the robot arm 22 in the charging robot 20. Further, as the detection device, for example, a door opening and closing detection sensor, a trunk opening and closing detection sensor, or an up switch and an down switch. The detection result of the detection device is transmitted to the charging service control server 4 by the communication device provided in the vehicle 100 by wireless communication.

The charging service control server 4 can determine whether there is an operation of the charge port 101 displaced in the vertical direction based on the detection result of the detection device received from the vehicle 100. For example, the charging service control server 4 can determine whether the door 110 is open or closed based on the detection result of the door open/close detection sensor. Further, the charging service control server 4 can determine whether there is opening and closing of the trunk 102 based on the detection result of the trunk opening and closing detection sensor. Further, the charging service control server 4 can determine whether the electric air suspension is operated based on the pressing signal of the up switch or the down switch.

Thus, in the automatic charging system according to the embodiment, after obtaining the position information of the charging port 101 of the vehicle 100 by the camera 24 of the charging robot 20 until the insertion of the charging connector 33 to the charging port 101 is completed, even if the opening and closing operation of the door 110, the opening and closing operation of the trunk 102, or vehicle height adjustment operation by the electric air suspension is performed, based on the correct position information of the latest charging port 101, it is possible to insert the charging connector 33 to the charging port 101.

It should be noted that as the position information acquisition device for obtaining the position information of the charging port 101 in the charging target vehicle 100 parked in the parking space 11, it is not limited to the camera 24 provided on the robot arm 22 in the charging robot 20. For example, a camera provided in the robot body 21 in the charging robot 20, a camera or the like provided in the parking lot 10 may be used as a position information acquisition device for acquiring the position information of the charging port 101.

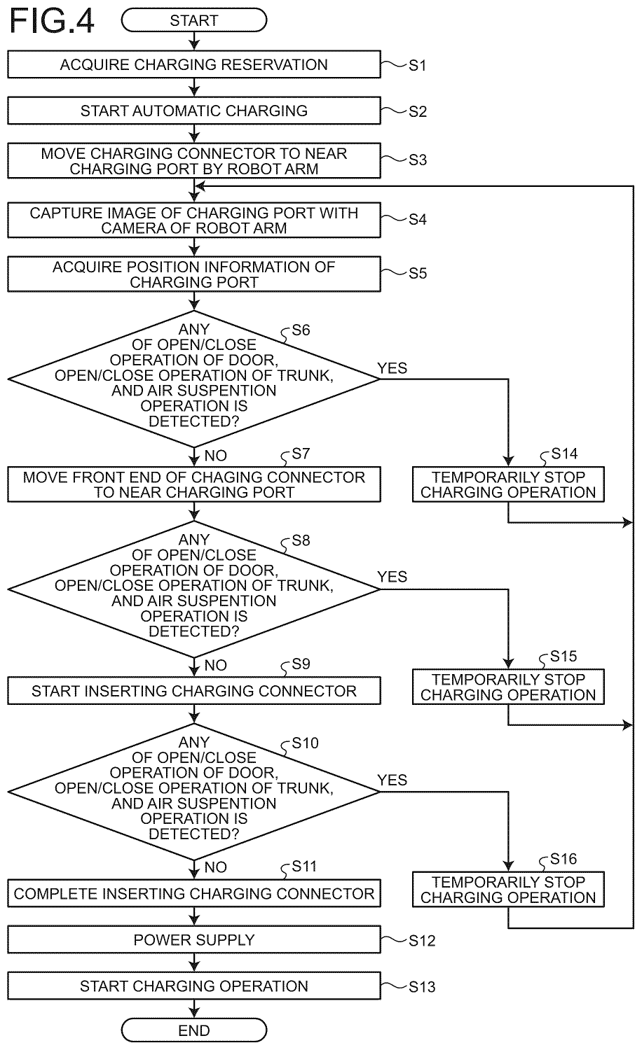

FIG. 4 is a flowchart illustrating an example of an automatic charging control according to an embodiment.

First, in step S1, the charging service control server 4 acquires the charging reservation from the user 3. Next, in step S2, the server controller of the charging service control server 4 instructs the auto charging device 2 to start charging. Next, in step S3, the robot controller of the charging robot 20 executes control to move the charging connector 33 to the vicinity of the charging port 101 by the robot arm 22. Next, in step S4, the robot controller captures the charging port 101 of the vehicle 100 with the camera 24 of the robot arm 22. Next, in step S5, the robot controller acquires the position information of the charging port 101 based on the image data of the charging port 101 captured by the camera 24, and calculates the position coordinates of the charging port 101.

Next, in step S6, the server controller determines whether the door 110 is open or closed, the trunk 102 is open or closed, or the electric suspension is operated, based on the process result of the detection device received from the vehicle 100. When the server controller determines that the open or close of the door 110, the open or close of the trunk 102, or the operation of the electric suspension is detected (Yes at step S6), the process proceeds to step S14. In step S14, the server control device causes the robot control device to perform control to suspend the charging operation by the charging robot 20. Thereafter, the process proceeds to step S4. On the other hand, when the server control device determined that none of the open and close of the door 110, the open and close of the trunk 102, and the operation of the electric suspension is detected (No in step S6), the process proceeds to step S7. In step S7, the server control device moves the robot arm 22 or the like based on the position information of the charging port 101 (position coordinates), and causes the robot controller to perform control for moving the front end of the charging connector 33 to the center of the charging port 101.

Next, in step S8, after moving the front end of the charging connector 33 to the center of the charging port 101, the server control device determines whether this is the opening and closing of the door 110, the opening and closing of the trunk 102, or the operation of the electric suspension based on the newly received the detection result of the detection device from the vehicle 100. When the server controller determines that any of the opening and closing of the door 110, the opening and closing of the trunk 102, and the operation of the electric suspension is detected (Yes in step S8), the process proceeds to step S15. In step S15, the server control device causes the robot control device to perform control to suspend the charging operation by the charging robot 20. Thereafter, the process proceeds to step S4. On the other hand, when the server control device determines that any of the opening and closing of the door 110, the opening and closing of the trunk 102, and the operation of the electric suspension is not detected (No in step S8), the process proceeds to step S9. In step S9, the server controller causes the robotic controller to perform control to initiate a plug operation of the charging connector 33 to the charging port 101.

Next, in step S10, after starting the plug-in operation of the charging connector 33 to the charging port 101, the server control device determines whether any of the opening and closing of the door 110, the opening and closing of the trunk 102, and the operation of the electric suspension is detected based on the newly detection result by the detection device received from the vehicle 100. When the server controller determines that any of the opening and closing of the door 110, the opening and closing of the trunk 102, and the operation of the electric suspension is detected (Yes in step S10), the process proceeds to step S16. In step S16, the server control device causes the robot control device to perform control to suspend the charging operation by the charging robot 20. Thereafter, the process proceeds to step S4. On the other hand, when the server control device determines that any of the opening and closing of the door 110, the opening and closing of the trunk 102, and the operation of the electric suspension is not detected (No in step S10), the process proceeds to step S11.

In step S11, the plugging operation of the charging connector 33 to the charging port 101 by the charging robot 20 is completed. Next, in step S12, the server controller supplies power to the batteries of the vehicles 100 from the charger 30 to charge the batteries. Next, in step S13, when the charging of the battery of the vehicle 100 is completed, the server controller terminates the charging operation by the charging robot 20. Thereafter, the server controller terminates the series of automatic charge control.

The automatic charging system 1 according to the embodiment, even when the charging port 101 is displaced in the vertical direction during the time period from when the position information of the charging port 101 is acquired to when the insertion of the charging connector 33 to the charging port 101 is completed, the charging connector 33 can be inserted into the charging port 101 based on the latest position information of the charging port 101.

The automatic charging system according to the present disclosure has an effect that it is possible to insert the charging connector to the charging port based on the latest position information of the charging port.

According to an embodiment, it is possible to insert the charging connector to the charging port based on the position information of the latest charging port.

According to an embodiment, it is possible to acquire the position information of the charging port by photographing the charging port by using the imaging device after moving the robot arm to a position near the charging port.

According to an embodiment, it is possible to prevent the charging connector from being inserted into the charging port while the position of the charging port is shifted in the vertical direction due to an occurrence of the opening and closing operation of the door and then getting on and off of the passenger with respect to the vehicle.

According to an embodiment, it is possible to prevent the charging connector from being inserted into the charging port while the position of the charging port is shifted in the vertical direction, which is caused by loading and unloading of the load in the trunk due to the opening and closing operation of the trunk.

According to an embodiment, it is possible to prevent the charging connector from being inserted into the charging port while the position of the charging port is shifted in the vertical direction, which is caused by the vehicle height adjustment operation by the electric air suspension.

What is claimed is:

1. An automatic charging system comprising:
a vehicle, which is driven by power supplied from a power storage device;
a charger, which is equipped with a charging cable having a charging connector;
a position information acquisition device for obtaining position information of a charging port of the vehicle located in a parking space;
a charging robot having a robot arm, which grasps the charging connector and automatically insert and remove the charging connector into and from the charging port; and
a detection device, which detects an operation of the charging port displaced in a vertical direction, wherein
the charging robot is configured to insert the charging connector into the charging port based on the position information to supply power from the charger to the power storage device for charging,
and wherein in a case where the detection device detects the operation of the charging port displaced in the vertical direction during a time period from when the position information acquisition device acquires the position information to when the insertion of the charging connector into the charging port is completed, the acquisition of the position information by the position information acquisition device is newly done again.

2. The automatic charging system according to claim 1, wherein the position information acquisition device is provided on the robot arm to capture an image of the charging port.

3. The automatic charging system according to claim 1, wherein the operation of the charging port displaced in the vertical direction is an operation of opening and closing of a door provided in the vehicle.

4. The automatic charging system according to claim 1, wherein the operation of the charging port displaced in the vertical direction is an operation of opening and closing of a trunk provided in the vehicle.

5. The automatic charging system according to claim 1, wherein the operation of the charging port displaced in the vertical direction is a vehicle height adjusting operation by an electric air suspension provided in the vehicle.
